(19) United States
(12) Patent Application Publication
(10) Pub. No.: US 2022/0250019 A1
(43) Pub. Date: Aug. 11, 2022

(54) ROTATIONAL DEVICE

(71) Applicant: Uplifting Products Ltd, Malmesbury (GB)

(72) Inventor: Thomas Alexander Lawton, Malmesbury (GB)

(21) Appl. No.: 17/572,417

(22) Filed: Jan. 10, 2022

(30) Foreign Application Priority Data
Jan. 8, 2021 (GB) 2100276.1

(51) Int. Cl. B01F 27/119; B44C 5/00; F04D 25/08; F04D 29/38

(52) U.S. Cl. CPC B01F 27/119; F04D 29/384; F04D 25/08; B44C 5/00

(57) ABSTRACT

A rotational device which finds application as a kinetic sculpture, a record stabilizer, an air agitator or an impeller comprises a helical curved member having a first elongate helical portion defining a first helix of first radius about a first axis and a second elongate helical portion of opposing handedness defining a second helix of a second radius, smaller than the first radius, about a second axis, and a proximal intermediate portion linking a first or lower end of the first helical portion and a proximal first or lower end of the second helical portion, wherein the second helical portion defines an internal cylindrical volume that is unoccupied and absent any central shafts or struts, a rotational support base or apparatus for facilitating rotation of the helical curved member and a mounting arrangement for mounting the helical curved member to the rotational support base or apparatus.

### FIELD OF THE INVENTION

This invention relates to the field of rotational devices. In particular the invention relates to rotational devices configured to provide a weight to records, to provide a visual effect as a kinetic sculpture, to agitate or circulate air or for use as a mixer.

### BACKGROUND OF THE INVENTION

Many existing kinetic mechanisms and kinetic sculptures or toys include kaleidoscopes, spinning tops, etc. There is potential for further kinetic sculptures with new mechanisms and further applications.

Record weights commonly are made of a weighted materials, such as aluminium and provided with a spindle hole for fitting onto the spindle of a record player so that it can be fitted above a record in order to keep a record steady on a record player deck.

Many mixers utilise multiple blades for mixing liquid or fluid materials. There are instances, for example, of mixers or impellers utilising helical ribbon impellers in which a one or two opposing helical ribbons of equal diameter are mounted either side of a central support shaft by a series of horizontal struts. In one disclosure, there is one helical ribbon paddle mounted to a central shaft, which central shaft has a helical thread formed thereon of opposing handedness. These examples are described (and shown in FIG. 1) in the paper my M Robinson and P Cleary, “Flow and Mixing Performance in Helical Ribbon Mixers”, Chemical Engineering Science, 2012, 84, page 382-398, a study into the effect of impeller design on chaotic mixing, and available here: https://www.semanticsholar.org/paper/Flow-and-mixing-performance-in-helical-ribbon-Robinson-Cleary/794ad7c810e0c5598927a8ba2528909ee68a5739/figure/0.

Another helical ribbon impeller mixer is illustrated in Chinese utility model CN202893280U for use in producing attapulgite, which discloses two opposing handed helical ribbon paddles of different radius mounted onto a central shaft by a series of struts.

The present inventor has devised a helical rotational device that may be adapted to addresses each of the above applications providing improvements.

### Problem to be Solved by the Invention

It is an object of this invention to provide a rotational device with certain structural and aesthetic advantages.

It is a further object of the invention to provide a record weight.

It is further object of the invention to provide an improved agitator or mixer (for air/gas, fluids, liquids and particulate solids).

### SUMMARY OF THE INVENTION

In accordance with a first aspect of the invention, there is provided a rotational device comprising:

a helical curved member having a first elongate helical portion defining a first helix of first radius about a first axis and a second elongate helical portion of opposing handedness defining a second helix of a second radius about a second axis, and a proximal intermediate portion linking a first or lower end of the first helical portion and a proximal first or lower end of the second helical portion;

a rotational support base or apparatus for facilitating rotation of the helical curved member; and

a mounting arrangement for mounting the helical curved member to the rotational support base or apparatus.

In a second aspect of the invention, there is provided a mixer comprising:

paddle comprising a helical curved member having a first elongate helical portion defining a first helix of first radius about a first axis a second elongate helical portion of opposing handedness defining a second helix of a second radius, less than the first radius, about a second axis and defining an unoccupied internal and shaft-free space for the passage of fluid to be mixed, and a proximal intermediate portion linking a first or lower end of the first helical portion and a proximal first or lower end of the second helical portion;

a rotational drive member for facilitating rotation of the paddle; and

a mounting arrangement for mounting the paddle to the rotational drive member.

In a third aspect of the invention, there is provided a record stabiliser apparatus comprising:

a weighted base configured for fitting to a record player spindle for stabilizing a record, the weighted base having a record-contacting lower surface;

a helical curved member having a first elongate helical portion defining a first helix of first radius about a first axis and a second elongate helical portion of opposing handedness defining a second helix of a second radius about a second axis, which is the same as the first axis and a curved lower intermediate portion linking a lower end of the first helical portion and a proximal lower end of the second helical portion, the curved lower intermediate portion having a gradient of curvature along its length from the first helical portion to the second helical portion; and

a mounting arrangement comprising a base-cooperating portion provided on the helical curved member and a member-cooperating portion provided on the base,

wherein the mounting arrangement is configured such as to dispose the helical curved member relative to the base such that the rotational axis of the base and the axes of the first and second helical portions are coaxial.

In a fourth aspect of the invention, there is provided a helical curved member for use in a rotational device as defined above, the helical curved member comprising a first elongate helical portion defining a first helix of first radius about a first axis and a second elongate helical portion of opposing handedness defining a second helix of a second radius about a second axis, and a proximal intermediate portion linking a first or lower end of the first helical portion and a proximal first or lower end of the second helical portion.

In a fifth aspect of the invention, there is provided a mixer/impeller paddle for use in a mixer/impeller as defined above, wherein the impeller paddle comprises a helical curved member comprising a first elongate helical portion defining a first helix of first radius about a first axis and a second elongate helical portion of opposing handedness defining a second helix of a second radius about a second axis, a proximal intermediate portion linking a first or lower end of the first helical portion and a proximal first or lower end of the second helical portion, the second helical portion defining an unoccupied internal and shaft-free space for the passage of fluid being mixed, and base-cooperating mounting portion in the form of a spindle for cooperating with a paddle-cooperating mounting portion provided on rotational apparatus or rotational drive member.

### BRIEF DESCRIPTION OF THE DRAWINGS

FIG. 1 shows a perspective view of a record stabiliser of one embodiment of the rotational device of the invention;

FIG. 2 is a side view of a helical curved member for use in the record stabiliser of FIG. 1;

FIG. 3 is an end view of the helical curved member of FIG. 2.

FIG. 4A is a perspective exploded view of the record stabiliser of FIG. 1;

FIG. 4B is a close-up of part A of the view in FIG. 4A;

FIG. 5 is a first side view of a mixer of one embodiment of the rotational device of the invention; and

FIG. 6 is a second side view of a mixer of FIG. 5.

### DETAILED DESCRIPTION OF THE INVENTION

A rotational device according to the invention comprises a helical curved member, a rotational support base or apparatus for facilitating rotation of the helical curved member and a mounting arrangement for mounting the helical curved member to the rotational support base or apparatus. The mounting arrangement can comprise of at least two parts, including, optionally, a base-cooperating portion provided on the helical curved member and a member-cooperating portion provided on the rotational support base or apparatus.

The helical curved member has a first elongate helical portion which defines a first helix of a first radius, which for the extent of the helix a preferably constant (or generally constant) radius about a first axis and a second elongate helical portion of opposing handedness to the first helical portion, which defines a second helix of a second radius, which for the extent of the second helix is preferably constant (or generally constant) about a second axis. The first and second axes are preferably parallel and more preferably are coaxial.

The helical curved member further comprises a proximal intermediate portion, being proximal to the rotational support base or apparatus. The proximal intermediate portion links the first or lower (or proximal) end of the first helical portion and the first or lower (or proximal, to the rotational support base or apparatus or mount therefor) end of the second helical portion.

The proximal intermediate portion may be any suitable shape or configuration, but is typically not helical. It may be curved and may comprise (or the majority of it may consist) of elongate member of the same or similar general form as the helical portions. Typically, the proximal intermediate portion does not extend laterally more than the maximum lateral extent of the first helical portion. The length of the proximal intermediate portion is typically less than the total length of the elongate member making up the first and second helical portions and preferably less than the length of elongate member making up the first helical portion. Preferably, the proximal intermediate portion is a non-helical curved elongate member.

Preferably, a base-cooperating portion of the mounting arrangement is provided on the proximal intermediate portion of the helical curved member. The base-cooperating portion may be disposed at any suitable position relative to the helical portions. The base cooperating portion is preferably longitudinally separated from the helical portions and optionally may be disposed on the proximal intermediate portion at a lateral position that is within the diameter of the second helical portion or is between boundary of the second helical portion and the first helical portion. By boundary of the second and first helical portions, it is mean longitudinal projections of the boundary or definition of the first and second helical portions.

The base-cooperating mounting portion disposed on the curved helical member (e.g. disposed on or formed by the proximal intermediate portion) may take any suitable form. For example, it may be a spindle, centrally mounted (e.g. coaxial with the axis of the first and/or second helical portion) or off-set from the centre (but optionally having a longitudinal axis parallel with the axis of one or both of the helical portions). Alternatively, it may comprise a shaped flange for receipt in cooperating recess in the rotational support base or apparatus or a recess for receiving a cooperating spindle or flange disposed on the rotational support base or apparatus. In a preferred embodiment, the curved helical member, when mounted on the rotational support base or apparatus, is rotationally fixed relative to the or at least a portion (e.g. the member-cooperation mounting portion) of the rotation support base or apparatus.

Preferably, the helical curved member further comprises a distal intermediate portion being a portion linking the distal ends of the first and second helical portions. Preferably the distal intermediate portion is an elongate member of the same general form as the first and second helical portions. Preferably the distal intermediate portion is curved but is not helical. The distal intermediate portion preferably comprises a curved member which defines a curve of, for example, 180 degrees, but typically does not have a constant radius of curvature along its length.

Preferably, the helical curved member comprises the first and second helical portions and a proximal intermediate portion and a distal intermediate portion wherein the proximal and distal intermediate portions join the helical portions at transition points that represent the end of the helix, being the limit of the constant radius of the helical portion. The helical curved member is thus a continuous elongate member.

The first and second helical portions preferably define opposing handedness.

The first and second helical portions may each, independently, define at least a half rotation, preferably at least three-quarters of a rotation and more preferably about one rotation or at least one rotation. The helical portions may each independently define up to ten rotations, more preferably up to five rotations and optionally two or three rotations. Preferably, the helical portions each, independently, define a whole number of rotations. Preferably, in most embodiments, it is one rotation.

Preferably each of the first and second helical portions are cylindrical helices. The volume defined by the helix (e.g. the volume of the theoretical cylinder the helical member forming the helix winds around) may be considered the interior helical or cylindrical volume or space.

The first and second helical portions may be in phase or out of phase. In one preferred embodiment, the first and second helical portions have the same pitch and are 180° out of phase.

The pitch of the first and second helical portions (by which it is meant the distance between points defining one complete turn of the helix measured parallel to the axis of the helix) may be the same or different. Preferably, the pitch of the first or second helical portions is a whole number multiple of the other helical portion. For example, the pitch of the first helical portion may be 1×, 2× or 3× the pitch of the second helical portion or vice versa. Preferably, however, the pitch of the first and second helical portions is the same.

The radius of the first helical portions is preferably larger than the second helical portion. Preferably, the first helical portion has a radius of from 1.25× to 5× the radius of the second helical portion, preferably from 1.5× to 3× the radius of the second helical portion, more preferably from 1.75 to 2.5× the radius and still more preferably about 2× the radius (e.g. plus or minus 10%).

The ratio of the pitch of the first helical portion to the radius of the first helical portion may be any suitable value, for example it may be in the range from 0.5× the radius of the first helical portion to 10× the radius of the first helical portion, preferably from 1 to 5×, e.g. from 1.5 to 3× the radius of the first helical portion and most preferably about 2× the radius of the first helical portion (e.g. +/−10%). The second helical portion may also have a ratio of pitch to radius of any suitable amount, subject to requirements or preferences as to the ratio of pitch between the first and second helical portions, for example the ratio of pitch to radius of second helical portion may be from 0.5:1 to 10:1, preferably 1:1 to 8:1, sill more preferably 2:1 to 6:1, more preferably 3:1 to 5:1 and preferably the pitch of the second helical portion is 4× the radius thereof (e.g. from 3.5 to 4.5, such as 4× +/−10%).

The helical curved member may take any suitable form. For example the helical curved member may be a wire or tube of circular, triangular, square, rectangular, pentagonal, hexagonal, heptagonal, octagonal or other cross-section, which cross-sectional shape may be regular or irregular and optionally may be any other shape such as a star, semi-circular, new moon shaped or is an ellipse. Preferably, the helical curved member is a ribbon member which may have, for example an elliptical, rectangular or irregular cross-section, preferably elliptical, but is in any case defined by having a ribbon width that is significantly greater than the ribbon depth. Preferably the width is at least 2× the depth and may be up to 20× the depth, but is preferably from 5× to 10× the depth (taking the depth as the maximum or average/mean depth of the ribbon).

The ratio of the helical curved member or ribbon width at the first helical portion to the radius of the first helical portion may be any suitable ratio, but is preferably from 1:1 to 1:10, more preferably from 1:2 to 1:6, still more preferably from 1:3 to 1:5 and ideally around 1:4 (e.g. from 1:3.5 to 1:4.5). The ratio of the helical curved member or ribbon width at the second helical portion to the radius of the second helical portion may be any suitable ratio, but is preferably from 1:0.5 to 1:5, more preferably from 1:1 to 1:3, still more preferably from 1:1.5 to 1:2.5 and ideally around 1:2.

The angle at which the helical curved member in the form of a ribbon is disposed relative to the axis of the helix of each of the first and second helical portions may be any suitable angle, but preferably it is disposed at an angle to the normal, e.g. at around 45 degrees one way or the other. Preferably, the ribbon is disposed at an angle of from 30 to 60 degrees form the normal to the axis of the respective helical portion.

Preferably, the helical curved member comprises a second helical portion which defines a cylindrical volume that is unoccupied and absent any central shafts or struts.

The helical curved member may be formed of any suitable material. For example, the helical curved member may be formed of a metal or metal alloy (e.g. copper, steel, aluminium) or may be formed of a plastic (any suitable polymer may be used) or may be a reinforced polymer (e.g. a fibre-reinforced polymer) or may be of a plastic with a metal coating or metal core with a plastic coating. The member may be formed by any suitable method, e.g. by bending wire or ribbon of metal, and in one example by 3D printing.

The helical curved member may be of any suitable size according to its function and requirements.

The rotational support base or apparatus may, according to the particular application, be configured to enable or cause the helical curved member to rotate relative to the rotational support base (or the remainder thereof) or it may be configured itself to be rotatable (e.g. by being located on a further rotating or rotatable) mechanism. In one embodiment, the mounting arrangement is configured to mount the helical curved member on the base such that it is rotationally fixed relative to the base, in which embodiment the base is preferably configured to rotate, e.g. by being mounted a further rotating or rotatable mechanism or platform or deck. According to this embodiment, it is preferable that the axis of rotation of the base is parallel or more preferably coaxial with one or preferably both helical portions. According to a still more preferred embodiment, the mounting means may enable mounting of the helical curved member at a position offset from the axis of rotation of the base and the axes of the first and second helical portions, preferably offset by a distance intermediate between the radii of the first and second helical portions. In another embodiment, the mounting arrangement is configured to mount he helical curved member onto the rotational support base, whereby the mounting means comprises a cooperating base-cooperating portion on the helical curved member and a member-cooperating portion on the helical curved member wherein the helical curved member may rotate relative the member-cooperating portion or may be rotationally fixed relative to the member-cooperating portion, but the rotationally-cooperating portion rotatable relative the remainder of the rotational support base or apparatus. Preferably, according to this embodiment, the mounting means is centrally mounted relative the axes of the first and second helical portions, preferably with a rotational axis that is coaxial with the first and second helical portions.

The device may be for use as or may be any device with a rotational requirement as defined above. According to general embodiments of the invention, the rotational device may be a record stabilizer, a kinetic sculpture, an air or fluid agitator or a mixer/impeller.

According to a first general embodiment of the invention, the rotational device is a record stabilizer. A general embodiment of another aspect comprises a helical curved member for use on a record stabilizer.

Preferably, according to this general embodiment, the record stabilizer comprises a weighted base configured for fitting to a record player spindle for stabilizing a record, the weighted base having a record-contacting lower surface. Preferably, a spindle hole is provided in the lower surface for receipt of the record player spindle. Preferably, the weighted base has an upper surface comprising a member-cooperating portion, for cooperating with a base-cooperating portion on the helical curved member to form a mounting arrangement.

The weighted base may be made of any suitable materials, such as metals or plastics or even wood or a combination thereof, one preferred embodiment being a machined aluminum. In any case, it is preferable that the base member has a weight of from about 300 to 700 g, preferably about 350 to 650 g.

Preferably, the weighted base is of generally rotationally symmetrical form, and is preferably generally cylindrical. The diameter or width of the weighted base is preferably from 70 to 120 mm, preferably 80 to 100 mm

Preferably, in this general embodiment, the axes of the first and second helical portions of the helical curved member are the same.

Preferably, the helical curved member comprises a curved proximal or lower intermediate portion linking a proximal or lower end of the first helical portion and a proximal lower end of the second helical portion, the curved proximal intermediate portion having a gradient of curvature along its length from the first helical portion to the second helical portion. Preferably the curved proximal intermediate portion defines a 180° turn. Preferably, the curved proximal intermediate portion according to this general embodiment does not pass through a volume defined by a longitudinal projection of the internal or cylindrical volume defined by the second helical portion.

The helical curved member preferably comprises a curved distal intermediate portion linking a distal end of the first helical portion and a distal end of the second helical portion, the curved distal intermediate portion having a gradient of curvature along its length from the first helical portion to the second helical portion. Preferably the curved distal intermediate portion defines a 180° turn. Preferably, the curved distal intermediate portion according to this general embodiment does not pass through a volume defined by a longitudinal projection of the internal or cylindrical volume defined by the second helical portion.

Together, preferably, the first helical portion, the distal intermediate portion, the second helical portion and the proximal intermediate portion define a continuous elongate member, which is preferably in the form of a ribbon. The helical curved member may thus form a self-supporting member defining a closed loop.

The helical curved member preferably has a first helical portion with a radius of about 50 to 100 mm, more preferably 60 6to 90 mm and still more preferably about 75 to 85 mm and a second helical portion having a smaller radius of about 20 to 75 mm, preferably 25 to 60 mm, more preferably 35 to 45 mm.

Preferably, a base-cooperating mounting means is provided on the curved proximal intermediate portion of the helical curved member, preferably at a position on the proximal intermediate portion offset from the axes of the first and second helical portions by an amount intermediate the radii of the first and second helical portions and preferably about half-way between the radii of the first and second helical portions. Preferably, the base-cooperating mounting means is disposed at the lowest part of the proximal intermediate portion when the axes of the first and second helical portions are disposed vertically. The base cooperating means preferably comprises an elongate member or flange which is not rotationally symmetrical, but preferably has an axis that is parallel with the axis of the first and second helical portions.

Preferably a corresponding member-cooperating portion is provided on an upper surface of the weighted base. In a preferred embodiment, this is a recess shaped to receive the elongate member provided as the base-cooperating portion, more preferably to receive it in a conforming recess whereby the helical curved member does not rotate relative to the base member.

Preferably the member-cooperating portion is provided on the upper surface of the weighted base at a position offset from the axis of the spindle hole by an amount the same as the offset amount of the base-cooperating portion and is configured such that when mounted, the axes of the spindle hole of the weighted base and the first and second helical portions are coaxial.

Preferably the mounting arrangement is such that it appears, when cooperating, that the helical curved member is simply resting on the upper surface of the weighted base at the proximal intermediate portion.

Preferably, the helical curved portion provides an additional weight to the record stabilizer, by an amount of say 20 to 200 g and preferably from 50 to 100 g.

The helical curved portion preferably has a height of 10 to 25 cm.

When the record stabilizer is rotated on a record player deck, it serves to stabilize the record while the helical curved member appears to move continuously appearing to flow across the upper surface of the weighted base.

The record stabilizer may serve, by virtue of rotation of the helical curved member in a continuous fashion during operation of a record player deck (responsible for its rotation) to agitate and cause movement and potentially a flow of air across the record, thereby reducing the risk of particles of dust settling on the record and thereby improving the performance of the record player.

According to a second general embodiment of the invention, the rotational device is a kinetic sculpture. A general embodiment of another aspect comprises a helical curved member for use in a kinetic sculpture.

According to this general embodiment, the features of the first general embodiment generally apply in terms of the helical curved member (except the sizes, as this can be of any size that is desired) and the mounting arrangement. The base may be similar but may be different. The rotational support base may be any suitable base which is itself rotatable with an axis of rotation corresponding to the axes of the first and second helical portion. The base may be a rotatable disc, a turntable, a cylindrical rotatable base, a flywheel or any other suitable structure. Optionally, the base is rotatable manually, has a wind-up mechanism, a thermally-initiated mechanism, a solar-power rotational drive member or other electrical driven mechanism.

According to a third general embodiment of the invention, the rotational device is an air agitator. A general embodiment of another aspect comprises a helical curved member as an agitation means or fan for use in an air agitator.

According to a fourth general embodiment of the invention, the rotational device is a mixer. A general embodiment of another aspect comprises a helical curved member as a paddle or impeller for use in a mixer.

The features of this general embodiment are generally applicable to the air agitator embodiment.

According to this general embodiment, the helical curved member comprises a first elongate helical portion defining a first helix of first radius about a first axis and a second elongate helical portion of opposing handedness defining a second helix of a second radius, smaller than the first radius, about a second axis, which is preferably the same as the first axis, the second helical portion defining an unoccupied internal cylindrical volume and shaft-free space for the passage of fluid being mixed. Preferably the impeller is absent an axial shaft disposed between the first end and the second end for supporting the paddle or helical portions.

The first and second helical portions may each define any suitable number of 360° turns, which may be the same or different, preferably a whole number of turns. The radius, member shape and width and pitch may be any suitable quantities as required for the circumstances (e.g. the nature of the media to be mixed and the mixing requirements). Preferably, the first and second helical portions each define one 360° turn and preferably the first helical portion has a radius between 1.5 and 2.5× the radius of the second helical portion. Preferably the pitch of the first and second helical portions is between 1.5 and 3× the radius of the first helical portion.

The helical curved member preferably has a first helical portion with a radius of about 50 to 100 mm, more preferably 60 to 90 mm and still more preferably about 75 to 85 mm and a second helical portion having a smaller radius of about 20 to 75 mm, preferably 25 to 60 mm, more preferably 35 to 45 mm.

The helical curved member may have any suitable total length, for example from the proximal end of the helical portions to the distal end of the helical curved member may be from 50 to 120 mm for a food mixer impeller (preferably 60 to 80 mm), for example, or from 100 to 500 mm, preferably up to 250 mm, and preferably from 125 to 175 mm for use in particulate use. For other applications, such as industrial mixing the helical curved member may be adapted to have a suitable size/dimensions.

Preferably, the proximal intermediate portion according to this general embodiment is configured to extend from each the proximal ends of the first and second helical portions and then curve toward the direction of the longitudinal axes of the first and second helical portions but in a direction away from the first and second helical portions to meet at a point in line with the axes of the first and second helical portions. For example, the proximal intermediate portion may have two components, each extending from either the first helical portion or the second helical portion, which may spiral from the transition points of the first and second helical portions to a confluence of both components at a point on the axes of the first and second helical portions. A base-cooperating mounting portion is formed on the proximal intermediate portion, preferably in the form of spindle where the curved parts of the proximal intermediate portion meet. The spindle preferably has an axis of rotation coaxial with the axes of the first and second helical portions.

Preferably, the helical curved portion has a distal intermediate portion which are generally as described in respect of the first general embodiment.

Preferably each of the first and second helical portions are cylindrical helices. The volume defined by the helix (e.g. the volume of the theoretical cylinder the helical member forming the helix winds around) may be considered the interior helical or cylindrical volume or space.

Preferably, the helical curved member extends from a proximal intermediate portion via the first helical portion, the distal intermediate portion, the second helical portion to the proximal intermediate portion via a continuous elongate member which is self-supporting. Thus, it defines a closed loop. The internal cylindrical volume (defined by the second helical portion) is preferably unoccupied and there is no requirement for any supporting shaft or struts extending therefrom within the internal cylindrical volume. This allows more efficient fluid flow and better and more controllable mixing.

The helical curved member forming the impeller or paddle is preferably formed as a ribbon member, preferably having a generally flat surface of elliptical cross-section of suitable width to achieve the necessary balance of causing movement of the media to be mixed while being able to be moved or cut through the media.

The angle at which the helical curved member in the form of a ribbon is disposed relative to the axis of the helix of each of the first and second helical portions may be any suitable angle. It may be disposed at an angle normal to the axis or an angle to the normal, e.g. from 60° from the normal to 60° to the normal (e.g. a range of 120°), preferably at an angle of up to 45° either side of the normal. Optionally, the helical curved member, and in particular the helical curved member in the first and second helical portions, may (independently for each helical portion) be disposed at a constant angle to the axis or, more preferably at a variable angle along its length whereby the ribbon forms a twist along its length.

The width of the ribbon and the angle of the ribbon (or its cross-section) relative to the axis of the helical portions, as well as the number, pitch and radius of turns in the first and second helical portions may be tuned in its design according to particular requirements of the impeller for a particular situation, including the viscosity of the fluid, the particle size of any particulates, the size and nature of the vessel and the nature of the mixing required.

The paddle-cooperating portion on the base may comprise any suitable means for cooperating with the base-cooperating portion of the paddle or impeller. Preferably, the paddle or member-cooperating portion comprises a socket member for receiving a spindle of the impeller, the socket member being rotationally mounted on an apparatus, preferably configured with a rotational drive mechanism for rotating the socket member, whereby the impeller when received in the socket member is caused to rotate.

Typically, the rotational drive mechanism is an electrically operated device (such as an electric whisk driver).

Optionally, the socket member is rotationally mounted on an apparatus that is manually rotated or the spindle is configured to rotate within the socket member for passive rotation as it is moved through a media.

The apparatus for facilitating rotation of the impeller may have one or optionally two or more socket members for receiving impellers in a side-by-side or other (e.g. staggered where more than two) arrangement whereby it may mix a media.

The apparatus for facilitating rotation of the impeller may, for example, be provided on an extended arm, provided as part of a vessel for mixing media (e.g. a chemical/industrial mixing/reaction vessel), or may comprise a handheld device.

The mixer may be configured for mixing a medium or media comprising a fluid or mix of fluids, which may be a liquid medium and another liquid medium or a gas medium or a fluid solid (e.g. a particulate solid). Alternatively, it may be for agitating or mixing a particulate solid, optionally mixing in a further particulate solid.

In a further aspect or embodiment of the invention, the mixer may be defined as a device for mechanically agitating a fluid, the device comprising a first end, a second end, and a paddle arrangement, wherein the paddle arrangement comprises an inner helical portion disposed between the first end and the second end and around a first rotational axis, and having a maximum radial extent; and an outer helical portion disposed between the first end and the second end and around a second rotational axis, having a minimum radial extent larger than the maximum radial extent of the inner helical portion, wherein, when the inner helical portion is rotated about the first rotational axis it moves fluid in a first direction and when the outer helical portion is rotated about the second rotational axis it moves fluid in a second direction opposite to the first direction, characterised in that the device is absent an axial shaft disposed between the first end and the second end for supporting the paddle arrangement

The invention will now be described in more detail, without limitation, with reference to the accompanying Figures.

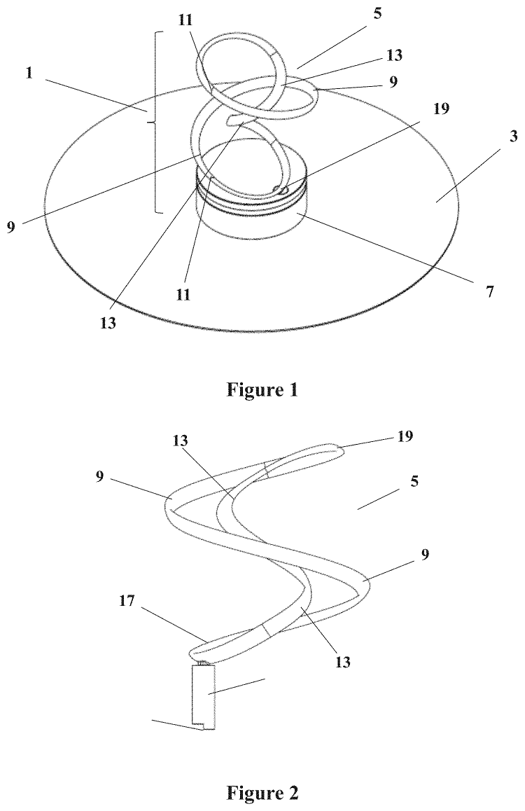

In FIG. 1, a record stabiliser 1 is disposed on an LP record 3 situated on a turntable (not shown). The record stabiliser 1 comprises a base 7 which is located so that a hole (not shown) in the underside of the base 7 receives a spindle (not shown) of the record player. The hole in the underside of the base 7 is centrally located in the base 7, so that it receives the spindle of the record player centrally and is rotationally symmetrical relative to the record player deck. A continuous curved ribbon member 5 is disposed on the base 7, which acts as a rotational means for the curved ribbon member 5 by way of its engagement with the rotating record player deck whereby the curved ribbon member can perform as a kinetic sculpture. Together, the base 7, which is made of machined aluminium, and the curved ribbon member 5, made by 3D printing as a composite, have a combined weight of 400 to 700 g. The curved ribbon member 5 has a first (or outer) elongate helical portion 9 in which the ribbon member defines one rotation at a first radius of about 80 mm (measured to the outside of the ribbon member) and a second (or inner) elongate helical portion 13 in which the ribbon member has an opposite handed helix to the outer member 9 and defines one rotation at a second, smaller, radius of about 40 mm (measured to the outside of the ribbon member). The outer helical portion 9 extends between outer helix transition points 11 (indicated in FIG. 2) while inner helical portion 13 extends between inner helix transition points 15. A proximal intermediate portion 17 of the ribbon member 5 having a non-constant radius along its length links the inner and outer helix transition points 11, 15 proximal to the base 7, while a distal intermediate portion 19 of the ribbon member 5, again having a non-constant radius along its length, links the inner and outer helix transition points 11,15 distal to the base 7. The helical portions 9,13 and the transition portions 17,19 together provide a continuous elongate ribbon member 5. The ribbon member 5 preferably has a flat, ribbon-like profile, in this case about 6 mm wide.

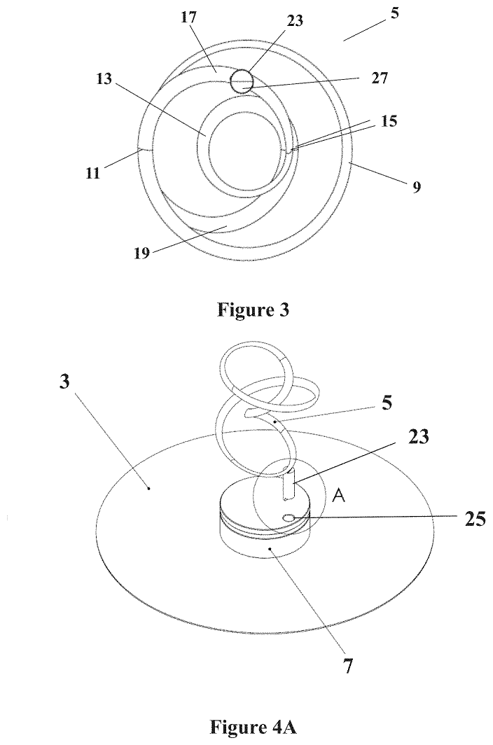

The rotational axes of the outer and inner helical portions 9,13 are preferably parallel and in this case, as apparent from FIG. 3, which is a view of the elongate ribbon member 5 from the base end, the rotational axes of the outer and inner helical portions 9,13 are the same.

The helical elongate ribbon member 5 is mounted on the base 7 so that the rotational axes of the outer and inner helical portions 9.13 are coaxial with the spindle-receiving hole (not shown) in the underside of the base 7. This means that when the record stabiliser device 2 rotates on a record player deck, the ribbon of the inner and outer helical portions 9,13 appear to be moving upward or downward. The helical elongate ribbon member 5 is mounted on the base 7 by way of a mounting arrangement 21.

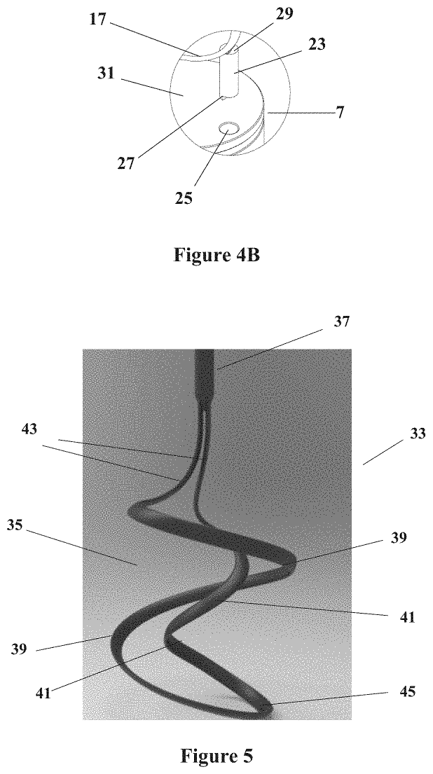

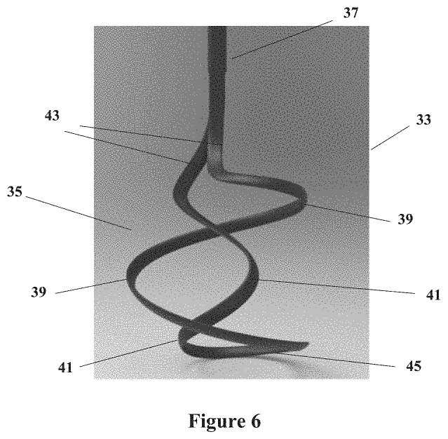

As can be seen in FIGS. 4A and 4B (being a close-up of the mounting arrangement 21 shown in circle A in FIG. 4A), the mounting arrangement 21 is made up of a base-cooperating cylinder member 23 disposed on the proximal intermediate portion 17 of the ribbon member 5 and a cylinder member-receiving recess 25 formed in the base, for receiving the cylinder member. The base-cooperating cylinder member 23 has a elongate axis that is parallel with the axes of rotation of the inner and outer helical portions 9, 13 and is provided with a key 27 for engaging with a corresponding recess part (not shown) to inhibit relative rotation of the cylinder member 23 and the recess 25 and, indeed, the ribbon member 5 and the base 7. The cylinder top surface 29 of cylinder member 23 is parallel with the base top surface 31 when the two parts are engaged. As the cylinder member 23 is disposed on the lowest part of the ribbon member (when the rotational axis of the helical portions 9,13 are disposed vertically) and there is no part of the ribbon member that passes within a column defined by the inner helical portion 13, when the record stabiliser device rotates, it appears as if the helical ribbon member 5 is flowing about its path and the point of contact with the base does not look constant, while one of the helical portions 9,13 appears to be moving upward while the other appears to be moving downward, giving a mesmerising visual effect.

In FIG. 5, a mixer paddle 33 comprises a helical curved paddle member 35 mounted to a spindle 37 for coupling with a rotational drive member or apparatus (not shown) with a coupling recess for receiving a spindle 37. Such a coupling recess and a spindle 37 together provide a mounting arrangement for the mounting the mixer paddle 33 to the rotational drive member. The helical curved paddle member 35 comprises a first outer elongate helical portion 39 of a ribbon member defining a first helix of first, constant, radius about a first axis for one 360° turn and a second inner elongate helical portion 41 of a ribbon-like member of opposing handedness defining a second helix of a second, constant, radius, smaller than the first radius, about a second axis for one 360° turn. The first and second axes are the same/coaxial. A proximal intermediate paddle portion 43 links a first or proximal end of the first helical portion 39 and a proximal end of the second helical portion 41 to the spindle 37. A distal intermedial paddle portion 45 links a distal end of the first helical portion 39 and a distal end of the second helical portion 41 by way of a ribbon like member defined a 180° turn, so that the first helical portion 39, distal intermediate paddle portion 45 and second helical portion 41 define one continuous paddle member.

The proximal intermediate paddle portion 43 is shaped to extend from the proximal ends of the inner and outer helices 39,41 to a parallel arrangement and to form or join to a spindle 37 which is disposed with its axis parallel to and preferably coaxial with the axes of the first and second helical portions 39,41.

Upon rotation of the paddle 33, in a medium to be mixed, the outer helical portion 39 will cause the media to be pushed in a first direction with a vertical component, while the second helical portion 41 will cause the media to be pushed in a second, opposing direction with a vertical component. This has the effect of mixing the media as well as ensuring a good depth of mixing by vertical movement of the media rather than purely rotational in conventional mixing devices.

The invention has been described with reference to a preferred embodiment. However, it will be appreciated that variations and modifications can be effected by a person of ordinary skill in the art without departing from the scope of the invention.

What is claimed is:

1. A rotational device comprising
a helical curved member having a first elongate helical portion defining a first helix of first radius about a first axis and a second elongate helical portion of opposing handedness defining a second helix of a second radius, smaller than the first radius, about a second axis, and a proximal intermediate portion linking a first or lower end of the first helical portion and a proximal first or lower end of the second helical portion, wherein the second helical portion defines an internal cylindrical volume that is unoccupied and absent any central shafts or struts;
a rotational support base or apparatus for facilitating rotation of the helical curved member; and
a mounting arrangement for mounting the helical curved member to the rotational support base or apparatus.

2. The device as claimed in claim 1, wherein the device comprises a full-turn of the first helix about the first axis and a full-turn of the second helix about the second axis, the first and second helices being coaxial and opposite-handed.

3. The device as claimed in claim 1, wherein the helical curved member is a ribbon-like member.

4. The device as claimed claim 3, wherein the helical curved member further comprises a distal intermediate portion linking the distal end of the first helical portion and the second helical portion.

5. The device as claimed claim 4, wherein the mounting arrangement comprising a base-cooperating portion provided on the helical curved member and a member-cooperating portion provided on the rotational support base or apparatus.

6. The device as claimed in claim 5, wherein the mounting arrangement is configured such as to dispose the helical curved member relative to the base such that the rotational axis of the base or apparatus and the axes of the first and second helical portions are coaxial.

7. The device as claimed in claim 1, wherein the device comprises a record stabilizer.

8. The device as claimed in claim 7, wherein the record stabilizer comprises
a weighted base configured for fitting to a record player spindle for stabilizing a record, the weighted base having a record-contacting lower surface;
a helical curved member having a first elongate helical portion defining a first helix of first radius about a first axis and a second elongate helical portion of opposing handedness defining a second helix of a second radius about a second axis, which is the same as the first axis and a curved lower intermediate portion linking a lower end of the first helical portion and a proximal lower end of the second helical portion, the curved lower intermediate portion having a gradient of curvature along its length from the first helical portion to the second helical portion; and
a mounting arrangement comprising a base-cooperating portion provided on the helical curved member and a member-cooperating portion provided on the base,
wherein the mounting arrangement is configured such as to dispose the helical curved member relative to the base such that the rotational axis of the base and the axes of the first and second helical portions are coaxial.

9. The device as claimed in claim 1, wherein the device comprises a kinetic sculpture.

10. The device as claimed in in claim 1, wherein the device comprises an air agitator.

11. The device as claimed in claim 1, wherein the device comprises a mixer/impeller.

12. The device as claimed in claim 11, wherein the mixer/impeller comprises a paddle comprising the helical curved member which includes a distal intermediate portion linking distal ends of the first and second helical portions and wherein the second helical portion defines an unoccupied internal and shaft-free space for the passage of fluid being mixed, the mixer further comprising a rotational drive member.

13. The helical curved member for use in a rotational device as claimed in claim 11, wherein the helical curved member comprises a first elongate helical portion defining a first helix of first radius about a first axis and a second elongate helical portion of opposing handedness defining a second helix of a second radius about a second axis, and a proximal intermediate portion linking a first or lower end of the first helical portion and a proximal first or lower end of the second helical portion.

14. An impeller paddle for use in a mixer/impeller as claimed in claim 12, wherein the impeller paddle comprises a helical curved member comprising a first elongate helical portion defining a first helix of first radius about a first axis and a second elongate helical portion of opposing handedness defining a second helix of a second radius about a second axis, a proximal intermediate portion linking a first or lower end of the first helical portion and a proximal first or lower end of the second helical portion, the second helical portion defining an unoccupied internal and shaft-free space for the passage of fluid being mixed, and base-cooperating mounting portion in the form of a spindle for cooperating with a paddle-cooperating mounting portion provided on rotational apparatus or rotational drive member.
